(19) United States
(12) Patent Application Publication
(10) Pub. No.: US 2021/0010893 A1
(43) Pub. Date: Jan. 14, 2021

(54) DEVICE AND METHOD FOR PIPELINE LEAK DETECTION USING PARTICLE SWARM OPTIMIZATION-VARIATIONAL MODE DECOMPOSITION ALGORITHM

(71) Applicant: Nanjing Tech University, Nanjing (CN)

(72) Inventors: Juncheng JIANG, Nanjing (CN); Xu DIAO, Nanjing (CN); Lei NI, Nanjing (CN); Haitao BIAN, Nanjing (CN); Zhaozhao CHI, Nanjing (CN); Chengwei CHU, Nanjing (CN); Zhirong WANG, Nanjing (CN); Guodong SHEN, Nanjing (CN)

(21) Appl. No.: 17/037,575

(22) Filed: Sep. 29, 2020

Related U.S. Application Data
(63) Continuation-in-part of application No. PCT/CN2019/074083, filed on Jan. 31, 2019.

(30) Foreign Application Priority Data
Jan. 29, 2019 (CN) 201910083494.7

(51) Int. Cl. G01M 3/02; G05D 7/06

(52) U.S. Cl. CPC G01M 3/02; G05D 7/0635

(57) ABSTRACT

The disclosure provides a pipeline leak detection device and a leak detection method based on the variational mode decomposition optimized by the particle swarm (PSO-VMD). The acoustic emission signals with leakage and without leakage are collected by the acoustic emission system. Since the decomposition result of the traditional VMD depends on the selection of the parameter preset scale K and the penalty coefficient α, the PSO is employed to obtain the optimal parameters of the VMD. The optimized parameters are input into VMD to decompose the original signals, and then K intrinsic mode functions (IMFs) can be obtained. After the signal reconstruction for de-noising, based on the energy ratio, the time-domain features are extracted and the support vector machine (SVM) is used to detect the leak.

### CROSS-REFERENCE TO RELATED APPLICATIONS

This application is a continuation-in-part of International Patent Application No. PCT/CN2019/074083 with an international filing date of Jan. 31, 2019, designating the United States, now pending, and further claims foreign priority benefits to Chinese Patent Application No. 201910083494.7 filed Jan. 29, 2019. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure related to the field of leakage detection of pipeline, and more particularly to a device and a method for pipeline leak detection.

Known methods for leakage detection of pipelines involve hardware-based technology such as acoustic emission technology, fiber-optic sensing technology, and magnetic flux leakage testing technology, and software-based technology such as mass/flow balance method, negative pressure wave method, and transient-flow method. The acoustic emission technology is widely used for detection of leakage of pipelines. When a pipeline leaks, fluid-structure coupling will occur, which causes stress waves (i.e. acoustic emission waves) to propagate along the pipeline. The acoustic emission sensors can capture the acoustic emission waves, which helps to detect and locate pipeline leaks.

Acoustic emission signals are susceptible to the background noise including mechanical noise and electrical noise. The known methods for removing the background noise from the acoustic emission signals include wavelet transform (WT), empirical mode decomposition (EMD) and local mean decomposition (LMD). The wavelet transform is restricted by the selection of a mother wavelet. The empirical mode decomposition and the local mean decomposition have the phenomenon of end effect and modal aliasing.

### SUMMARY

The disclosure provides a device for leakage detection of a pipeline using PSO-VMD method. The device comprises a water tank, a submersible pump, a pipeline, and an acoustic emission system.

The submersible pump is placed in the water tank. The pipeline comprises a first end connected to the water tank and a second end connected to the submersible pump, thereby forming a circulating flow.

The acoustic emission system comprises a plurality of acoustic emission sensors, a plurality of preamplifiers, and a computer host with an acoustic emission signal processing card; the plurality of acoustic emission sensors is installed on the pipeline to collect and transmit acoustic emission signals to the plurality of preamplifiers, and then the acoustic emission signals are amplified and transmitted to the computer host for further processing.

The plurality of acoustic emission sensors is an R15a sensor with a resonant frequency of 150 kHz.

The computer host comprises an 8-channel PCI-2 acoustic emission card for signal acquisition and processing.

The pipeline is a cast iron pipe with an inner diameter of 102 mm and a wall thickness of 3 mm.

The submersible pump is a three-phase oil-filled submersible electric pump purchased from SHIMGE Pump Industry Group Co., Ltd., with a rated head of 18 m.

The disclosure also provides a method for pipeline leak detection using PSO-VMD method, the method comprising:
1) placing the plurality of acoustic emission sensors on the pipeline; connecting the plurality of acoustic emission sensors to the plurality of preamplifiers, and connecting the plurality of preamplifiers to the computer host;
2) starting the submersible pump and filling water in the pipeline;
3) collecting, by the plurality of acoustic emission sensors, acoustic emission signals, and transmitting the acoustic emission signals to the computer host;
4) selecting an information entropy of the acoustic emission signals as an optimization function of a particle swarm optimization (PSO) algorithm, and optimizing a preset scale K and α penalty coefficient α of variational mode decomposition (VMD) using the particle swarm optimization (PSO) algorithm;
5) inputting optimized parameters K and α in 4) to the VMD to decompose the collected acoustic emission signals, thereby acquiring K intrinsic mode functions (IMFs) with different center frequencies; calculating a signal energy of each IMF, and extracting a plurality of IMFs whose total signal energy ratio exceeds 80% of a raw signal energy for signal reconstruction; and
6) analyzing a reconstructed signal, extracting time domain parameters comprising a root mean square (RMS) and a square root amplitude of the reconstructed signal, and detecting the leakage of the pipeline with a support vector machine (SVM) algorithm.

The pipeline is provided with a control valve; the method further comprises closing the control valve to imitate no leakage of the pipeline; collecting the acoustic emission signals without leakage by the acoustic emission sensors, and transmitting the signals to the computer host.

The pipeline is provided with a control valve; the method further comprises opening the control valve to imitate the leakage of the pipeline, collecting the acoustic emission signals with leakage by the acoustic emission sensors, and transmitting the signals to the computer host.

Variational mode decomposition (VMD) is a method for processing non-stationary signals. It can effectively solve the problems like end effect and mode aliasing. However, the performance of VMD highly depends on the selection of the parameters. To avoid the interference of artificial selection of the parameters, the particle swarm optimization (PSO) is introduced for self-selection of the parameters automatically.

The acoustic emission signals with leakage or and leakage are processed by the proposed PSO-VMD method. The VMD method can be regarded as an approach to solve the constrained variational problem, where the process of the VMD is as follows:

$$\begin{matrix}{min}_{\{ {u}_{k} \} , \{ {ω}_{k} \}} \{ {\sum }_{k} {‖ {\partial }_{t} [ ( δ ( t ) + \frac{j}{π t} ) \times {u}_{k} ( t ) ] {e}^{- j {w}_{t} t} ‖}_{2}^{2} \} & ( 1 ) \\ {\sum }_{k} {u}_{k} = f & ( 2 )\end{matrix}$$

where t represents the time; j²=−1; the intrinsic mode functions (IMFs) are {uₖ}={u₁,u₂, . . . ,uₖ}; k is the k^{th} intrinsic mode function; the center frequencies of the intrinsic mode functions are {ωₖ}={ω₁, ω₂, . . . , ωₖ}; δ(t) is the Dirac distribution; and ƒ represents the original signal.

To find the optimal solution to the constraint Eqs. (1) and (2), a Lagrangian multiplier λ, and a quadratic penalty coefficient α can be introduced to construct an augmented Lagrangian function, as shown in Eq.(3):

$$L ( \{ {u}_{k} \} , \{ {ω}_{k} \} , λ ) = α {\sum }_{k} {‖ {\partial }_{t} [ ( δ ( t ) + \frac{j}{π t} ) \times {u}_{k} ( t ) ] {e}^{- j {w}_{t} t} ‖}_{2}^{2} + {‖ f ( t ) - {\sum }_{k} {u}_{k} ( t ) ‖}_{2}^{2} + 〈 λ ( t ) , f ( t ) - {\sum }_{k} {u}_{k} ( t ) 〉 \qquad ( 3 )$$

Alternate direction method of multipliers (ADMM) is used to find a solution of Eq. (3), by which the original signals are decomposed into K IMFs. The saddle point of Eq.(3) is obtained by alternately updating uₖⁿ⁺¹, ωₖⁿ⁺¹ and λⁿ⁺¹. The iterative process is shown as Eqs. (4)-(6):

$$\begin{matrix}{\hat{u}}_{k}^{n + 1} ( ω ) ← \frac{\hat{f} ( ω ) {\sum }_{i < k} {\hat{u}}_{i}^{n + 1} ( ω ) - {\sum }_{i < k} {\hat{u}}_{i}^{n} ( ω ) + \frac{{\hat{λ}}^{n} ( ω )}{2}}{1 + 2 {α ( ω - {ω}_{k}^{n} )}^{2}} & ( 4 ) \\ {ω}_{k}^{n + 1} ← \frac{{\int }_{0}^{∞} ω {\vert {\hat{u}}_{i}^{n + 1} ( ω ) \vert}^{2} d ω}{{\int }_{0}^{∞} {\vert {\hat{u}}_{i}^{n + 1} ( ω ) \vert}^{2} d ω} & ( 5 ) \\ {\hat{λ}}^{n + 1} ( ω ) ← {\hat{λ}}^{n} ( ω ) + τ ( \hat{f} ( ω ) - {\sum }_{k} {\hat{u}}_{k}^{n + 1} ( ω ) ) & ( 6 )\end{matrix}$$

where τ is a Lagrangian coefficient; n is a natural number (n≥1). The VMD ends until Eq. (7) is satisfied.

$${\sum }_{k} \frac{• {\hat{u}}_{k}^{n + 1} - {\hat{u}}_{k}^{n} {•}_{2}^{2}}{• {\hat{u}}_{k}^{n} {•}_{2}^{2}} < ɛ \qquad ( 7 )$$

where ε is an iterative convergence stopped criterion.

The preset parameters (K and α) of VMD are optimized by the PSO. The detailed description of the PSO is as follows:

The position and the velocity of a particle i in a d-dimensional searching space are expressed as vectors. Assuming that the positions of the particle i are X=(x_{i,1},x_{i,2}, . . . x_{i,n}), and the velocities of a particle i are Vⁱ=(v_{i,1},v_{i,2}, . . . v_{i,n}). The particle i updates its position and velocity by tracking two optimal solutions in each iteration, that is, an individual extreme value Pᵢ and a global optimal solution in searching space P_{g}, Pᵢ=(p_{i,1}, p_{i,2}, . . . p_{i,n}), P_{g}=(p_{g,1}, p_{g,2}, . . . p_{g,n}). The Eqs.(8) and (9) are used to update the position and velocity of the particle i:

v_{id}(t+1)=ωv_{id}(t)+c₁rand( )[p_{id}−x_{id}(t)]+c₂rand( )[p_{gd}−x_{gd}(t)] (8)

x_{id}(t+1)=x_{id}(t)+v_{id}(t+1) (9)

where ω is an inertial weight; c₁ and c₂ are positive learning factors, usually c₁=c₂=2, and rand ( ) is a random number between 0 and 1.

The leakage signals have specific characteristics, that is, the information entropy is larger than that of signals without leakage. The information entropy is thus employed as an objective function optimized using the PSO algorithm. The formulas for the information entropy are as follows:

$$\begin{matrix}{H}_{i} = - {\sum }_{i = 1}^{K} {p}_{i} {log}_{2} ( {p}_{i} ) & ( 10 ) \\ 〈 α , K 〉 = arg max ( \frac{1}{K} {\sum }_{i = 1}^{K} {H}_{i} ) & ( 11 )\end{matrix}$$

The method for implementing the PSO-VMD method comprises:

4-1) setting an optimization function for the PSO method, and determining a range of values for the parameter (K, α);

4-2) initializing a position and a velocity of the particle swarm, that is, setting the parameter (K, α) as the initial position;

4-3) inputting the initial parameter (K, α) to the VMD method for decomposition of the acoustic emission signals, thus acquiring K IMFs; calculating the information entropy of each IMF, comparing the information entropy of all particles, and updating a local maximum value of the individuals and a global maximum value of the particle swarm;

4-4) updating the position and velocity of each of the particles according to Eqs.(8) and (9);

4-5) repeating 4-4) and 4-5) until the maximum iteration is reached, outputting the global maximum value of the particle swarm and the position of the corresponding particle, where the global maximum value of the particle refers to a maximum entropy, and the position of the corresponding particle refers to a combination (K, α) of parameters.

In 5), the signal energy of each IMF is calculated according to the following formula:

E=∫₀^{∞}|ƒ(t)|²dt (12)

where E refers to an energy value of the acoustic emission signals; ƒ(t) refers to an amplitude value of the acoustic emission signals in the time domain. the IMFs, whose total energy ratio exceeds 80% of the raw signal energy, are selected from {u₁, u₂, . . . , uₖ} for reconstruction of the signal, thereby removing the environmental noise and the mechanical noise from the acoustic emission signals, so that the reconstructed signal contains the most leakage information.

Advantages of the device and method for leakage detection of a pipeline using PSO-VMD method according to embodiments of the disclosure are summarized as follows. The acoustic emission signals are collected by the acoustic emission sensors and then decomposed using the PSO-VMD method. The signal reconstruction is based on the signal energy ratio. The time-domain features of the reconstructed signals are employed as the feature vectors for pattern recognition. The SVM is then used to distinguish between leakage signals and non-leakage signals, thereby detecting the leakage of the pipeline.

### BRIEF DESCRIPTION OF THE DRAWINGS

FIG. 1 is a flowchart of a method for leakage detection of a pipeline using PSO-VMD in accordance with one embodiment of the disclosure;

FIG. 2 is a schematic diagram of the acoustic emission device for leakage detection of a pipeline in accordance with one embodiment of the disclosure;

FIG. 3 is a time-domain diagram of an acoustic emission signal when a leakage occurs;

FIG. 4 is the decomposed IMFs by VMD and the corresponding frequency spectrums; and

FIG. 5 is a classification result based on SVM method.

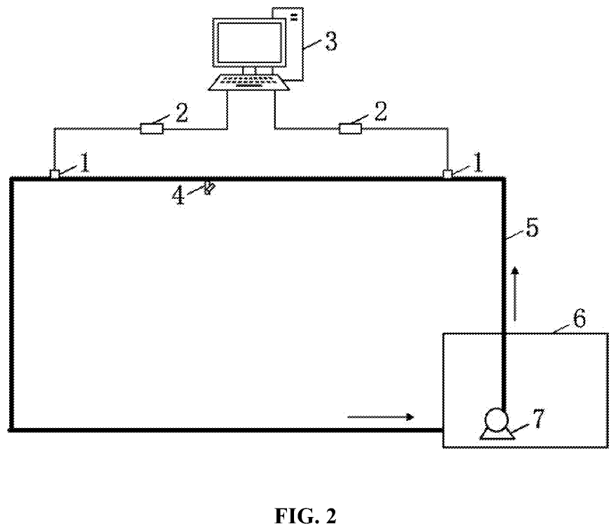

In FIG. 2, the following reference numbers are used: 1. Acoustic emission sensor; 2. Preamplifier; 3. Computer host; 4. Control valve; 5. Pipeline; 6. Water tank; 7. Pump.

### DETAILED DESCRIPTION OF THE EMBODIMENTS

To further illustrate the disclosure, embodiments detailing a device for leakage detection of a pipeline using PSO-VMD method are described below. It should be noted that the following embodiments are intended to describe and not to limit the disclosure.

The acoustic emission signals with leakage and no leakage are processed by the proposed PSO-VMD method. The VMD method can be regarded as an approach to solve the constrained variational problem, where the process of the VMD algorithm is as follows:

$$\begin{matrix}{min}_{\{ {u}_{k} \} , \{ {ω}_{k} \}} \{ {\sum }_{k} {‖ {\partial }_{t} [ ( δ ( t ) + \frac{j}{π t} ) \times {u}_{k} ( t ) ] {e}^{- j {w}_{t} t} ‖}_{2}^{2} \} & ( 1 ) \\ {\sum }_{k} {u}_{k} = f & ( 2 )\end{matrix}$$

where t represents the time; j²=−1; the intrinsic mode functions (IMFs) are {uₖ}={u₁,u₂, . . . ,uₖ}; k is the k^{th} intrinsic mode function; the center frequencies of the intrinsic mode functions are {ωₖ}={ω₁, ω₂, . . . , ωₖ}; δ(t) is the Dirac distribution; and ƒ is the original signal.

To find the optimal solution to the constraint Eqs.(1) and (2), a Lagrangian multiplier X, and a quadratic penalty coefficient α can be introduced to construct an augmented Lagrangian function, as shown in Eq.(3):

$$L ( \{ {u}_{k} \} , \{ {ω}_{k} \} , λ ) = α {\sum }_{k} {‖ {\partial }_{t} [ ( δ ( t ) + \frac{j}{π t} ) \times {u}_{k} ( t ) ] {e}^{- j {w}_{t} t} ‖}_{2}^{2} + {‖ f ( t ) - {\sum }_{k} {u}_{k} ( t ) ‖}_{2}^{2} + 〈 λ ( t ) , f ( t ) - {\sum }_{k} {u}_{k} ( t ) 〉 \qquad ( 3 )$$

Alternate direction method of multipliers (ADMM) is used to find a solution of Eq. (3), by which the original signals are decomposed into K IMFs. The saddle

point of Eq. (3) is obtained by alternately updating uₖⁿ⁺¹, ωₖⁿ⁺¹ and λⁿ⁺¹ . The iterative process is shown as Eqs. (4)-(6):

$$\begin{matrix}{\hat{u}}_{k}^{n + 1} ( ω ) ← \frac{\hat{f} ( ω ) {\sum }_{i < k} {\hat{u}}_{i}^{n + 1} ( ω ) - {\sum }_{i < k} {\hat{u}}_{i}^{n} ( ω ) + \frac{{\hat{λ}}^{n} ( ω )}{2}}{1 + 2 {α ( ω - {ω}_{k}^{n} )}^{2}} & ( 4 ) \\ {ω}_{k}^{n + 1} ← \frac{{\int }_{0}^{∞} ω {\vert {\hat{u}}_{i}^{n + 1} ( ω ) \vert}^{2} d ω}{{\int }_{0}^{∞} {\vert {\hat{u}}_{i}^{n + 1} ( ω ) \vert}^{2} d ω} & ( 5 ) \\ {\hat{λ}}^{n + 1} ( ω ) ← {\hat{λ}}^{n} ( ω ) + τ ( \hat{f} ( ω ) - {\sum }_{k} {\hat{u}}_{k}^{n + 1} ( ω ) ) & ( 6 )\end{matrix}$$

where τ is a Lagrangian coefficient; n is a natural number (n≥1). The VMD ends until Eq. (7) is satisfied.

$${\sum }_{k} \frac{• {\hat{u}}_{k}^{n + 1} - {\hat{u}}_{k}^{n} {•}_{2}^{2}}{• {\hat{u}}_{k}^{n} {•}_{2}^{2}} < ɛ \qquad ( 7 )$$

where ε is an iterative convergence stopped criterion.

The preset parameters (K and α) of VMD are optimized by PSO. The detailed description of PSO algorithm is as follows:

The position and the velocity of a particle i in a d-dimensional searching space are expressed as vectors. Assuming that the positions of the particle i are Xⁱ=(x_{i,1},x_{i,2}, . . . , x_{i,n}), and the velocities of the particle i are Vⁱ=(v_{i,1},v_{i,2}, . . . v_{i,n}), the particle i updates its position and velocity by tracking two optimal solutions in each iteration, that is, an individual extreme value Pᵢ and a global optimal solution in searching space P_{g}, Pᵢ=(p_{i,1},p_{i,2}, . . . p_{i,n}), P_{g}=(p_{g,1},p_{g,2}, . . . p_{g,n}). The Eqs.(8) and (9) are used to update the position and velocity of the particle i:

v_{id}(t+1)=ωv_{id}(t)+c₁rand( )[p_{id}−x_{id}(t)]+c₂rand( )[p_{gd}−x_{gd}(t)] (8)

x_{id}(t+1)=x_{id}(t)+v_{id}(t+1) (9)

where ω is an inertial weight, c₁ and c₂ are positive learning factors, usually c₁=c₂=2, and rand ( ) is a random number between 0 and 1.

The leakage signals have specific characteristics, that is, the information entropy is larger than that of signals without leakage. The information entropy is thus employed as an objective function optimized by PSO algorithm. The formulas for the information entropy are as follows:

$$\begin{matrix}{H}_{i} = - {\sum }_{i = 1}^{K} {p}_{i} {log}_{2} ( {p}_{i} ) & ( 10 ) \\ 〈 α , K 〉 = arg max ( \frac{1}{K} {\sum }_{i = 1}^{K} {H}_{i} ) & ( 11 )\end{matrix}$$

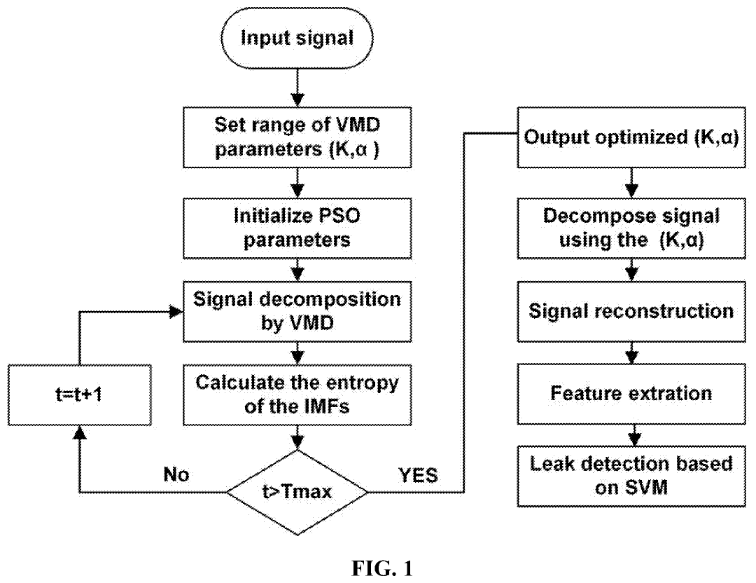

The acoustic emission signals are collected by the acoustic emission sensors and then transmitted to a computer host. As shown in FIG. 1, the method for leakage detection of a pipeline using PSO-VMD comprises:

1) Parameters setting in VMD: setting an optimization function for the PSO method, and determining a range of values for the parameter (K, α);

2) Generation of initial parameters of population in the PSO method: initializing a position and a velocity of a particle, that is, setting the parameter (K, α) as the position;

3) Decomposition of signals using VMD method: inputting the initial parameter (K, α) to the VMD for decomposition of the acoustic emission signals, thus acquiring K IMFs;

4) Calculation of information entropy of each IMF: comparing the information entropy of all of the particles, and updating a local maximum value of the individuals and a global maximum value of the particle swarm;

5) updating the position and velocity of each of the particles according to Eqs. (8) and (9);

6) repeating 3) and 5) until the maximum iteration is reached, outputting the global maximum value of the particle swarm and the position of the corresponding particle, where the global maximum value of the particle refers to a maximum entropy, and the position of the corresponding particle refers to a combination (K, α) of parameters;

7) the signal energy of each IMF is calculated in according to Eq.(12), and the IMFs, whose total energy ratio exceeds 80% of the raw signal energy, are selected for construction of the signal;

The signal energy of each IMF is calculated according to the following formula:

E=∫₀^{∞}|ƒ(t)|²dt (12)

where E refers to the energy of the acoustic emission signals; ƒ(t) refers to the amplitude values of the acoustic emission signals in the time domain. the IMFs, whose total energy ratio exceeds 80% of the raw signal energy, are selected from {u₁, u₂, . . . ,uₖ} for construction of the acoustic emission signals, thereby removing the environmental noise and the mechanical noise from the acoustic emission signals, so that the reconstructed signal contains the most leakage information; and

8) analyzing the reconstructed signals, extracting time domain parameter and then using SVM to detect a pipeline leak, where the time domain parameter includes the root mean square (RMS) and the square root amplitude.

Referring to FIG. 2, the device of the disclosure comprises a pipeline 5, a water tank 6, a submersible pump 7, and acoustic emission system. The acoustic emission system comprises acoustic emission sensors 1, preamplifiers 2, and a computer host 3, which are connected sequentially. The acoustic emission sensors 1 are disposed on the pipeline 5. The acoustic emission sensors 1 are connected to the preamplifiers 2, and the preamplifiers 2 are connected to the computer host 3. After the submersible pump 7 is turned on and the pipeline 5 is filled with water, the acoustic emission signals are collected by the acoustic emission sensors 1, and then transmitted to the computer host 3.

In an actual scene, the acoustic emission signals are susceptible to background noise including mechanical noise and electrical noise. The parameters of the device of the disclosure are shown in Table 1:

TABLE 1
Parameters of the device for pipeline
leakage detection using PSO-VMD

| | Inner | Wall | | Acoustic | |
|---|---|---|---|---|---|
| Length/ | diameter/ | thickness/ | Pressure/ | emission | Computer |
| m | mm | mm | MPa | sensor | host |
| 67 | 102 | 3 | 0.15 | R15a | PCI-2 |

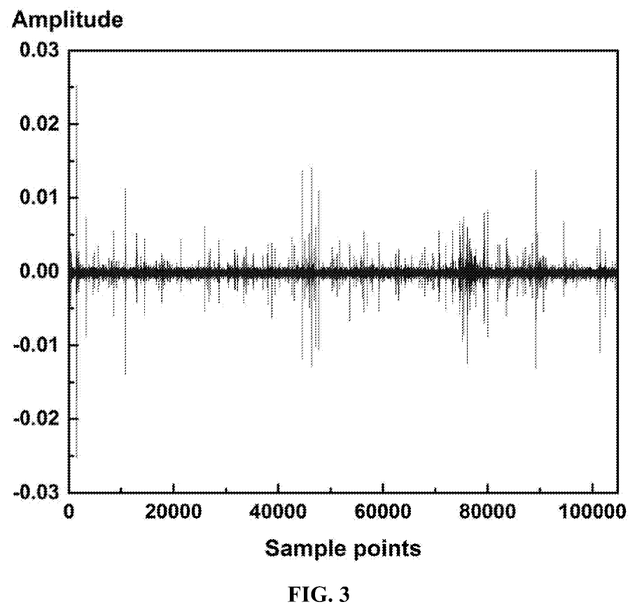

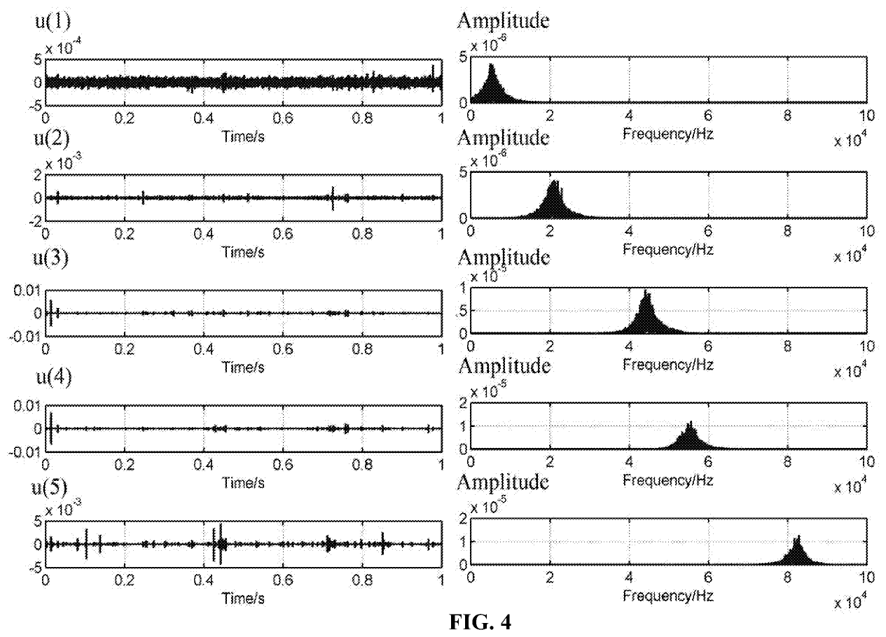

The acoustic emission signals with and without pipeline leaks are collected by the device, respectively, and then the PSO-VMD method is used to decompose the acoustic emission signals. A sample of original leakage signals as shown in FIG. 3 is taken as an example to be calculated using the PSO-VMD method. Firstly, two parameters K=5 and α=8333 are obtained by PSO method. Afterwards, the two parameters are input to the VMD method for decomposition of the signals, thus acquiring 5 IMFs that each is then converted to the corresponding frequency spectrum using Fourier transform. The decomposed results of the original signal based on the PSO-VMD method and the corresponding frequency spectrums are shown in FIG. 4. As shown in FIG. 4, the main frequency band of the original leakage signals is within a range of 45-55 kHz. On the other hand, the FIG. 4 also shows that the frequency bands of IMFs u(3) and u(4) are similar to that of the original signal.

The reconstruction signal is implemented based on the energy ratio method, in which the signal energy of each of the IMFs is as follows:

TABLE 2
Signal energy of each of the IMFs

| IMFs | u(1) | u(2) | u(3) | u(4) | u(5) |
|---|---|---|---|---|---|
| Energy | 0.000098 | 0.000105 | 0.003103 | 0.004125 | 0.000345 |

As shown in Table. 2, the energies of the two IMFs u(3) and u(4) are significantly higher than that of other IMFs, accounting for 93.0% of total energy of the original signal, which conforms to the properties shown in FIG. 4. The results show that the reconstruction of the signals can be implemented by removing the interference signals from the original leakage signals through the energy ratio method.

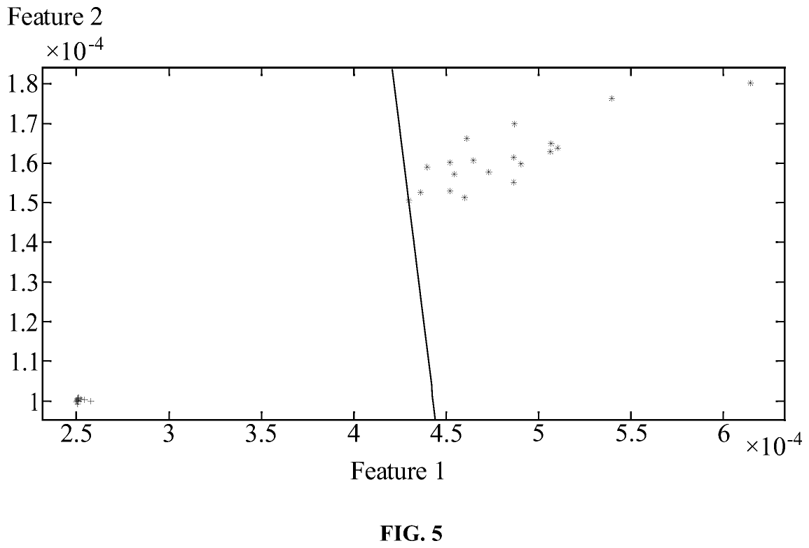

After the two IMFs u(3) and u(4) are employed to construct a reconstructed signal, the time domain features, including RMS and square root amplitude, of the reconstructed signal are extracted as the feature vectors. The number of training data is 80, and the number of testing data is 40. The predictive results of SVM are shown in FIG. 5, which shows that the leak signals can be detected by the proposed method.

It will be obvious to those skilled in the art that changes and modifications may be made, and therefore, the aim in the appended claims is to cover all such changes and modifications.

What is claimed is:

1. A device, comprising:
a water tank;
a submersible pump disposed in the water tank;
a pipeline comprising a first end connected to the water tank and a second end connected to the submersible pump; and
an acoustic emission system, the acoustic emission system comprising a plurality of acoustic emission sensors, a plurality of preamplifiers, and a computer host with an acoustic emission signal processing card; the plurality of acoustic emission sensors being installed on the pipeline to collect and transmit acoustic emission signals to the plurality of preamplifiers, and then the acoustic emission signals are amplified and transmitted to the computer host for further processing.

2. The device of claim 1, wherein the plurality of acoustic emission sensors is an R15a sensor with a resonant frequency of 150 kHz.

3. The device of claim 1, wherein the computer host comprises an 8-channel PCI-2 acoustic emission card for signal acquisition and processing.

4. The device of claim 1, wherein the pipeline is a cast iron pipe with an inner diameter of 102 mm and a wall thickness of 3 mm.

5. The device of claim 2, wherein the submersible pump is an oil-filled submersible electric pump with a rated head of 18 m.

6. A method for pipeline leak detection based on the PSO-VMD method using the device of claim 1, the method comprising:
1) placing the plurality of acoustic emission sensors on the pipeline; connecting the plurality of acoustic emission sensors to the plurality of preamplifiers, and connecting the plurality of preamplifiers to the computer host;
2) starting the submersible pump and filling water in the pipeline;
3) collecting, by the plurality of acoustic emission sensors, acoustic emission signals, and transmitting the acoustic emission signals to the computer host;
4) selecting an information entropy of the acoustic emission signals as an optimization function of a particle swarm optimization (PSO) algorithm, and optimizing a preset scale K and α penalty coefficient α of variational mode decomposition (VMD) using the particle swarm optimization (PSO) algorithm;
5) inputting optimized parameters K and α in 4) to the VMD to decompose the collected acoustic emission signals, thereby acquiring K intrinsic mode functions (IMFs) with different center frequencies; calculating a signal energy of each IMF, and extracting a plurality of IMFs whose total signal energy ratio exceeds 80% of a raw signal energy for signal reconstruction; and
6) analyzing a reconstructed signal, extracting time domain parameters comprising a root mean square (RMS) and a square root amplitude of the reconstructed signal, and detecting the leakage of the pipeline with a support vector machine (SVM) algorithm.

7. The method of claim 6, wherein the pipeline is provided with a control valve; the method further comprises closing the control valve to imitate no leakage of the pipeline; collecting the acoustic emission signals without leakage by the acoustic emission sensors, and transmitting the acoustic emission signals to the computer host.

8. The method of claim 6, wherein the pipeline is provided with a control valve; the method further comprises opening the control valve to imitate the leakage of the pipeline, collecting the acoustic emission signals with leakage by the acoustic emission sensors, and transmitting the acoustic emission signals to the computer host.

9. The method of claim 7, wherein in 4), the acoustic emission signals without leakage are processed by the PSO-VMD method.

10. The method of claim 8, wherein in 4), the acoustic emission signals with leakage are processed by the PSO-VMD method.
